(19) United States
(12) Patent Application Publication
(10) Pub. No.: US 2025/0352986 A1
(43) Pub. Date: Nov. 20, 2025

(54) LITHIUM-ION ADSORPTION MATERIAL, AND PREPARATION METHOD AND USE THEREOF

(71) Applicant: Hainan University, Haikou City (CN)

(72) Inventors: Lingbin LU, Haikou City (CN); Yutao XU, Haikou City (CN)

(21) Appl. No.: 19/008,037

(22) Filed: Jan. 2, 2025

(30) Foreign Application Priority Data
May 15, 2024 (CN) 202410601248.7

(51) Int. Cl. B01J 20/30; B01J 20/22

(52) U.S. Cl. CPC B01J 20/3071; B01J 20/226

(57) ABSTRACT

Disclosed are a lithium-ion adsorption material, a preparation method and use thereof. The preparation method includes: mixing sodium alginate, calcium carbonate, gluconolactone and water to obtain a sodium alginate hydrogel; The soaking the sodium alginate hydrogel into an oxidizing solution, and subjecting a resulting solution to oxidative ring-opening reaction to obtain an oxidized sodium alginate hydrogel; mixing the oxidized sodium alginate hydrogel, a dispersant, a solvent and a lithium-based compound, and subjecting an obtained mixture to aldol condensation reaction to obtain a lithium-based sodium alginate hydrogel; and subjecting the lithium-based sodium alginate hydrogel to acid-washing and freeze-drying in sequence to obtain the lithium ion adsorption material.

### CROSS REFERENCE TO RELATED APPLICATION

This patent application claims the benefit and priority of Chinese Patent Application No. 202410601248.7 filed with the China National Intellectual Property Administration on May 15, 2024, the disclosure of which is incorporated by reference herein in its entirety as part of the present application.

### TECHNICAL FIELD

The present disclosure relates to the technical field of adsorption materials, and in particular to a lithium-ion adsorption material, a preparation method and use thereof.

### BACKGROUND

Lithium is the lightest natural metal element, with a density of only 0.534 g/cm³, silver-white color, soft texture, very high electrochemical activity, high specific heat capacity and low coefficient of thermal expansion and other characteristics. Lithium and its compounds have been widely used in industrial manufacturing, aerospace, biomedicine and other fields. The demands for lithium and its compounds are gradually increasing.

Lithium is usually found in brine, seawater, clay and ores. Studies on the geographical distribution of global lithium resources show that 61.8% of lithium resources are found in brine, 59% of which are found in terrestrial brine. Lithium coexists with sodium, magnesium, calcium and other elements in the brine, making it difficult to extract lithium. Current methods applied to lithium extraction from the brine include precipitation method, adsorption method, extraction method, electrodialysis membrane method, and nanofiltration membrane separation technology. The adsorption method has advantages of simple production process, low production cost and low energy consumption. Adsorbents could be classified into two categories: inorganic adsorption materials and organic adsorption materials. The inorganic adsorption materials mainly include aluminum salt adsorbents, natural minerals, carbon materials, and lithium-ion sieves, etc. For example, manganese-based adsorbents with spinel structure can selectively adsorb lithium in brine with a specific selective effect on lithium ions. Studies have shown that a maximum adsorption capacity of the manganese-based adsorbents with the spinel structure for the lithium ions is 50 mg/g. The organic adsorption materials such as particles, fibers and porous materials usually use toxic small molecule crown ether monomers as ligands. These ligands could specifically coordinate lithium ions and achieve specific adsorption of lithium ions.

Currently, most adsorption materials are in the form of particles or powders. There are still problems of poor permeability and difficulty in recycling during the adsorption process. For example, a granular adsorbent will be crushed in the application process, making recovery difficult. It has become a bottleneck in industrial application of the adsorption method. Meanwhile, environmental friendliness and sustainability of the adsorbent materials are also key constraint on the industrial application of the adsorption method. Therefore, the development of environmentally friendly, permeable, easily recyclable and reusable adsorption materials is significant for lithium extraction and industrial development.

### SUMMARY

In view of deficiencies in the prior art, the present disclosure is intended to provide a lithium-ion adsorption material and a preparation method and use thereof.

To achieve the above objects, the present disclosure provides the following technical solutions:

The present disclosure provides a method for preparing a lithium-ion adsorption material, comprising:
1) mixing sodium alginate, calcium carbonate, gluconolactone and water to obtain a sodium alginate hydrogel;
2) soaking the sodium alginate hydrogel into an oxidizing solution, and subjecting a resulting solution to oxidative ring-opening reaction to obtain an oxidized sodium alginate hydrogel;
3) mixing the oxidized sodium alginate hydrogel, a dispersant, a solvent and a lithium-based compound, and subjecting an obtained mixture to aldol condensation reaction to obtain a lithium-based sodium alginate hydrogel; and
4) subjecting the lithium-based sodium alginate hydrogel to acid-washing and freeze-drying in sequence to obtain the lithium-ion adsorption material.

In some embodiments, in step 1), a mass to volume ratio of the sodium alginate, the calcium carbonate, and the gluconolactone to water is in a range of 0.5-1.25 g:0.045-0.12 g:0.16-0.41 g:25 mL.

In some embodiments, in step 2), the oxidizing solution is selected from the group consisting of a potassium permanganate solution and a sodium periodate solution, a mass to volume ratio of potassium permanganate to water in the potassium permanganate solution is in a range of 0.6-1.2 g:80 mL, and a mass to volume ratio of sodium periodate to water in the sodium periodate solution is in a range of 0.6-1.2 g:80 mL; and a mass to volume ratio of the sodium alginate hydrogel to the oxidizing solution is in a range of 25-30 g:80 mL.

In some embodiments, in step 2), the oxidative ring-opening reaction is conducted under a dark condition at a temperature of 40° C. to 60° C. for 8 h to 12 h.

In some embodiments, in step 3), the dispersant is selected from the group consisting of dimethyl sulfoxide, anhydrous ethanol, methanol and acetonitrile; the solvent is selected from the group consisting of diethylene glycol, triethylene glycol and dihydroxydibutyl ether; the lithium-based compound is selected from the group consisting of n-butyl lithium, lithium carbonate, propyl lithium and benzyl lithium; a mass to volume ratio of the oxidized sodium alginate hydrogel to the dispersant is in a range of 20-30 g:50-100 mL; under the condition that the lithium-based compound is selected from the group consisting of the n-butyl lithium, the propyl lithium and the benzyl lithium, a volume ratio of the solvent to the lithium-based compound is in a range of 0.5-1.5:0.3-1.5, and a mass to volume ratio of the oxidized sodium alginate hydrogel to the lithium-based compound is in a range of 20-30 g:0.3-1.5 mL; and under the condition that the lithium-based compound is lithium carbonate, a volume to mass ratio of the solvent to the lithium-based compound is in a range of 0.5-1.5 mL: 0.2-1 g, and a mass ratio of the oxidized sodium alginate hydrogel to the lithium-based compound is in a range of 20-30:0.2-1.

In some embodiments, in step 3), the aldol condensation reaction is conducted at a pH value of 10 to 12 for 6 h to 18 h.

In some embodiments, in step 4), the acid-washing is conducted using an acid solution at a concentration of 0.05 mol/L to 0.2 mol/L, the acid solution is selected from the group consisting of hydrochloric acid and nitric acid; the acid washing is conducted for 1 h to 2 h; a mass to volume ratio of the lithium-based sodium alginate hydrogel to the acid solution is in a range of 22-32 g:50-80 mL.

In some embodiments, in step 4), the freeze-drying is conducted at a temperature of −70° C. to −50° C. for 40 h to 60 h.

The present disclosure further provides a lithium-ion adsorption material prepared by the method according to the present disclosure.

The present disclosure further provides use of the lithium-ion adsorption material in extracting lithium from water.

Beneficial effects of some embodiments of the present disclosure are as follows:
1) In the present disclosure, sodium alginate is used as a matrix being oxidized to open rings with lithium ion as a template to produce a lithium-ion adsorption material via the imprinting effect and aldol condensation reaction, thereby achieving the purpose of adsorbing lithium ions, and providing a new idea for selective separation of lithium ions in brine.
2) In the present disclosure, the lithium-ion adsorption material has universal applicability, good permeability and stable mechanical properties during dynamic adsorption. The adsorption equilibrium could be reached within 24 hours, and an adsorption capacity for the lithium ions reaches 60 mg/g to 550 mg/g. And the lithium-ion adsorption material is easy to be recovered from water bodies, which could realize recycling and reduce the cost of lithium extraction.

### BRIEF DESCRIPTION OF THE DRAWINGS

FIG. 1 shows a scanning electron microscope (SEM) image of the lithium-ion adsorption material prepared in Example 2.

FIG. 2 shows a nuclear magnetic resonance (NMR) carbon spectroscopy of the lithium-ion absorption material prepared in Example 2.

FIG. 3 shows an infrared spectrum of the lithium-ion adsorption material prepared in Example 2, wherein a refers to an infrared spectrum curve of the sodium alginate hydrogel, b refers to an infrared spectrum curve of the oxidized sodium alginate hydrogel, and c refers to the infrared spectrum curve of the lithium-ion adsorption material.

### DETAILED DESCRIPTION OF THE EMBODIMENTS

The present disclosure provides a method for preparing a lithium-ion adsorption material, comprising:
1) mixing sodium alginate, calcium carbonate, gluconolactone and water to obtain a sodium alginate hydrogel;
2) soaking the sodium alginate hydrogel into an oxidizing solution, and subjecting a resulting solution to oxidative ring-opening reaction to obtain an oxidized sodium alginate hydrogel;
3) mixing the oxidized sodium alginate hydrogel, a dispersant, a solvent and a lithium-based compound, and subjecting an obtained mixture to aldol condensation reaction to obtain a lithium-based sodium alginate hydrogel; and
4) subjecting the lithium-based sodium alginate hydrogel to acid-washing and freeze-drying in sequence to obtain the lithium-ion adsorption material.

In some embodiments of the present disclosure, in step 1), a mass to volume ratio of the sodium alginate, the calcium carbonate, and the gluconolactone to water is in a range of 0.5-1.25 g:0.045-0.12 g:0.16-0.41 g:25 mL, and preferably 0.75-1 g:0.075-0.1 g:0.23-0.34 g:25 mL.

In some embodiments of the present disclosure, in step 1), the mixing is conducted under stirring; the mixing is conducted by mixing the sodium alginate with water, and then mixing a resulting mixture with the calcium carbonate and the gluconolactone in sequence. In some embodiments of the present disclosure, mixing the sodium alginate with the water is conducted at a rotational speed of 200 r/min to 350 r/min, and preferably 250 r/min to 300 r/min. In some embodiments of the present disclosure, mixing the sodium alginate with the water is conducted for 1 h to 3 h, and preferably 2 h. In some embodiments of the present disclosure, mixing the resulting mixture with the calcium carbonate is conducted at a rotational speed of 200 r/min to 350 r/min, and preferably 250 r/min to 300 r/min. In some embodiments of the present disclosure, mixing the resulting mixture with the calcium carbonate is conducted for 30 min to 60 min, and preferably 40 min to 50 min. In some embodiments of the present disclosure, mixing the resulting mixture with the gluconolactone is conducted at a rotational speed of 200 r/min to 350 r/min, and preferably 250 r/min to 300 r/min. In some embodiments of the present disclosure, mixing the resulting mixture with the gluconolactone is conducted for 1 min to 2 min.

In some embodiments of the present disclosure, in step 2), the oxidizing solution is selected from the group consisting of a potassium permanganate solution and a sodium periodate solution. In some embodiments of the present disclosure, a mass to volume ratio of potassium permanganate to water in the potassium permanganate solution is in a range of 0.6-1.2 g:80 mL, preferably 0.8-1.1 g:80 mL, and more preferably 1 g:80 mL. In some embodiments of the present disclosure, a mass to volume ratio of sodium periodate to water in the sodium periodate solution is in a range of 0.6-1.2 g:80 mL, preferably 0.8-1.1 g:80 mL, and more preferably 1 g:80 mL. In some embodiments of the present disclosure, a mass to volume ratio of the sodium alginate hydrogel to the oxidizing solution is in a range of 25-30 g:80 mL, preferably 26-29 g:80 mL, and more preferably 28 g:80 mL.

In some embodiments of the present disclosure, in step 2), the oxidative ring-opening reaction is conducted under a dark condition. In some embodiments of the present disclosure, the oxidative ring-opening reaction is conducted at a temperature of 40° C. to 60° C., preferably 45° C. to 55° C., and more preferably 50° C. In some embodiments of the present disclosure, the oxidative ring-opening reaction is conducted for 8 h to 12 h, preferably 9 h to 11 h, and more preferably 10 h.

In some embodiments of the present disclosure, in step 3), the dispersant is selected from the group consisting of dimethyl sulfoxide, anhydrous ethanol, methanol and acetonitrile. In some embodiments of the present disclosure, the solvent is selected from the group consisting of diethylene glycol, triethylene glycol and dihydroxydibutyl ether. In some embodiments of the present disclosure, the lithium-based compound is selected from the group consisting of n-butyl lithium, lithium carbonate, propyl lithium and benzyl lithium. In some embodiments of the present disclosure, a mass to volume ratio of the oxidized sodium alginate hydrogel to the dispersant is in a range of 20-30 g:50-100 mL, preferably 23-27 g:65-85 mL, and more preferably 25 g:75 mL. In some embodiments of the present disclosure, when the lithium-based compound is selected from the group consisting of n-butyl lithium, the propyl lithium and benzyl lithium, a volume ratio of the solvent to the lithium-based compound is in a range of 0.5-1.5:0.3-1.5, preferably 0.75-1.25:0.7-1.2, and more preferably 1:1; and a mass to volume ratio of the oxidized sodium alginate hydrogel to the lithium-based compound is in a range of 20-30 g:0.3-1.5 mL, preferably 23-27 g:0.7-1.2 mL, and more preferably 25 g:1 mL. In some embodiments of the present disclosure, when the lithium-based compound is the lithium carbonate, a volume to mass ratio of the solvent to the lithium-based compound is in a range of 0.5-1.5 mL: 0.2-1 g, preferably 0.75-1.25 mL: 0.4-0.8 g, and more preferably 1 mL:0.6 g; and a mass ratio of the oxidized sodium alginate hydrogel to the lithium-based compound is in a range of 20-30:0.2-1, preferably 23-27:0.4-0.8, and more preferably 25:0.6.

In some embodiments of the present disclosure, in step 3), the mixing is conducted under stirring. Mixing the oxidized sodium alginate hydrogel with the dispersant, and mixing a resulting mixture with the solvents and the lithium-based compounds in sequence to obtain a resulting reaction system. In some embodiments of the present disclosure, the mixing is conducted at a rotational speed of 200 r/min to 300 r/min, and preferably 250 r/min. In some embodiments of the present disclosure, a pH value of the resulting reaction system is adjusted using lithium hydroxide after the mixing.

In some embodiments of the present disclosure, in step 3), the aldol condensation reaction is conducted under stirring. In some embodiments of the present disclosure, a rotational speed of the stirring is 200 r/min to 300 r/min, and preferably 250 r/min. In some embodiments of the present disclosure, the aldol condensation reaction is conducted at a pH value of 10 to 12, and preferably 11. In some embodiments of the present disclosure, the aldol condensation reaction is conducted for 6 h to 18 h, preferably 8 h to 15 h, and more preferably 10 h to 12 h.

In some embodiments of the present disclosure, in step 4), the acid-washing is performed using an acid solution. In some embodiments of the present disclosure, the acid solution is at least one selected from the group consisting of hydrochloric acid and nitric acid. In some embodiments of the present disclosure, the acid washing is conducted for 1 h to 2 h, and preferably 1.5 h. In some embodiments of the present disclosure, the acid solution has a concentration of 0.05 mol/L to 0.2 mol/L, and preferably 0.1 mol/L to 0.15 mol/L. In some embodiments of the present disclosure, a mass to volume ratio of the lithium-based sodium alginate hydrogel to the acid solution is in a range of 22-32 g:50-80 mL, preferably 24-27 g:60-80 mL, and more preferably 25 g:75 mL.

In some embodiments of the present disclosure, in step 4), the acid-washing is conducted under stirring. In some embodiments of the present disclosure, a rotational speed of the stirring is 150 r/min to 250 r/min, and preferably 200 r/min.

In some embodiments of the present disclosure, in step 4), after the acid-washing, pre-cooling is conducted. In some embodiments of the present disclosure, the pre-cooling is conducted at a temperature of −30° C. to −10° C., and preferably −20° C. In some embodiments of the present disclosure, the pre-cooling is conducted for 6 h to 12 h, and preferably 8 h to 10 h.

In some embodiments of the present disclosure, in step 4), the freeze-drying is conducted at a temperature of −70° C. to −50° C., preferably −65° C. to −55° C., and more preferably −60° C. In some embodiments of the present disclosure, the freeze-drying is conducted for 40 h to 60 h, preferably 48 h to 55 h, and more preferably 50 h.

The present disclosure further provides a lithium-ion adsorption material prepared by the method for preparing the lithium-ion adsorption material as described above.

The present disclosure further provides use of the lithium-ion adsorption material as described above in extracting lithium ions from water.

The technical solutions provided by the present disclosure will be described in detail below in conjunction with examples, but these examples should not be understood as limiting the scope of the present disclosure.

### Example 1

1 g of sodium alginate was added to 25 mL of deionized water and stirred at 250 r/min for 2 h. Then 0.1 g of calcium carbonate was added thereto, and continuously stirred at 250 r/min for 40 min. Finally, 0.34 g of gluconolactone was added to a resulting system and continuously stirred at 250 r/min for 2 min. A resulting solution was poured into a mold, and subjected to gel to obtain a sodium alginate hydrogel.

1 g of potassium permanganate was mixed with 80 mL of deionized water to prepare a potassium permanganate solution. 26 g of the sodium alginate hydrogel was added to 80 mL of the potassium permanganate solution. A resulting mixture was subjected to oxidative ring-opening reaction under a dark condition at 50° C. for 10 h to obtain an oxidized sodium alginate hydrogel.

25 g of the oxidized sodium alginate hydrogel was dispersed in 75 mL of anhydrous ethanol, and 1 mL of diethylene glycol and 1 mL of propyl lithium were added thereto. A pH value of a resulting reaction system was adjusted to 10 using lithium hydroxide. And a resulting mixture was subjected to aldol condensation reaction at a stirring speed of 250 r/min for 8 h to obtain a lithium-based sodium alginate hydrogel.

27 g of the lithium-based sodium alginate hydrogel was added to 75 mL of a nitric acid solution. A concentration of the nitric acid solution is 0.1 mol/L. A resulting system was subjected to acid-washing at a speed of 200 r/min for 2 h. A sample was washed and pre-cooled at −20° C. for 10 h, and then freeze-dried at −60° C. for 48 h to obtain a lithium-ion adsorption material.

### Example 2

1.25 g of sodium alginate was added to 25 mL of deionized water and stirred at 300 r/min for 1 h. Then 0.12 g of calcium carbonate was added thereto, and continuously stirred at 300 r/min for 50 min. Finally, 0.41 g of gluconolactone was added to a resulting system and continuously stirred at 300 r/min for 1 min. A resulting solution was poured into a mold, and subjected to gel to obtain a sodium alginate hydrogel.

1 g of sodium periodate was mixed with 80 mL of deionized water to prepare a sodium periodate solution. 26 g of the sodium alginate hydrogel was added to 80 mL of the sodium periodate solution. A resulting mixture was subjected to oxidative ring-opening reaction under dark condition at 50° C. for 10 h to obtain an oxidized sodium alginate hydrogel.

25 g of the oxidized sodium alginate hydrogel was dispersed in 85 mL of dimethyl sulfoxide, and 1 mL of diethylene glycol and 1 mL of n-butyl lithium were added thereto. A pH value of a resulting reaction system was adjusted to 10 using lithium hydroxide. And a resulting mixture was subjected to aldol condensation reaction at a stirring speed of 200 r/min for 6 h to obtain a lithium-based sodium alginate hydrogel.

27 g of the lithium-based sodium alginate hydrogel was added to 80 mL of a hydrochloric acid solution. A concentration of the hydrochloric acid solution is 0.1 mol/L. A resulting system was subjected to acid-washing at a speed of 150 r/min for 1 h. A sample was washed and pre-cooled at −20° C. for 10 h, and then freeze-dried at −60° C. for 48 h to obtain a lithium-ion adsorption material.

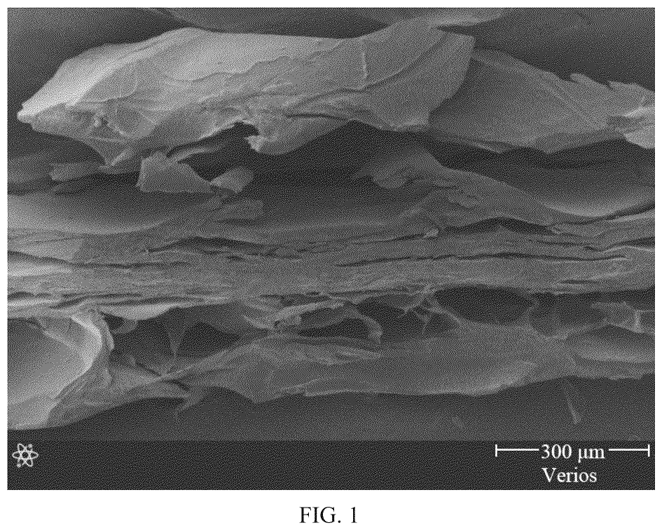

A scanning electron microscope (SEM) image of the lithium-ion adsorbent material prepared in this Example is shown in FIG. 1. In can be seen that there are more pore structures on surface of the lithium-ion adsorption material.

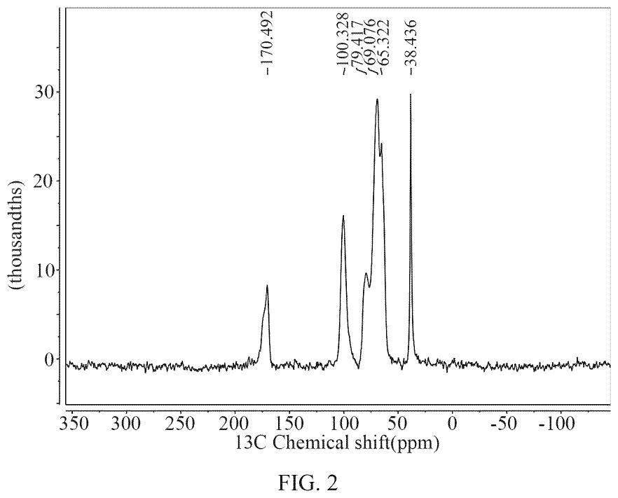

An NMR carbon spectroscopy of the lithium-ion adsorption material prepared in this Example is shown in FIG. 2. It can be seen that characteristic peaks of a new ring structure are obvious, indicating that the new ring has been formed in the lithium-ion adsorption material.

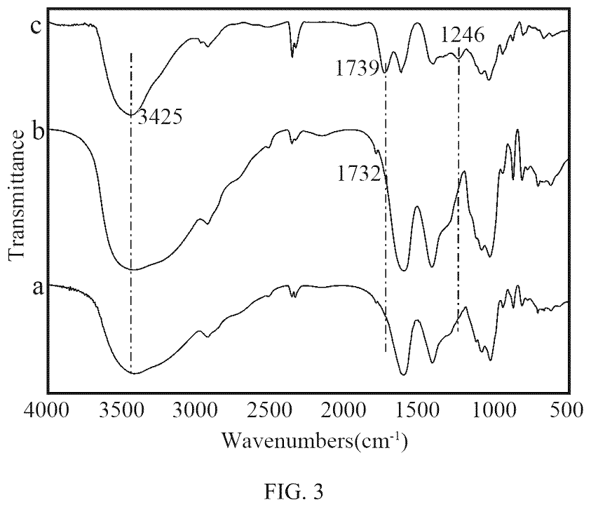

An infrared spectrum of the lithium-ion adsorption material prepared in this Example is shown in FIG. 3, wherein a refers to an infrared spectrum curve of the sodium alginate hydrogel, b refers to an infrared spectrum curve of the oxidized sodium alginate hydrogel, and c refers to the infrared spectrum curve of the lithium-ion adsorption material.

### Example 3

1.25 g of sodium alginate was added to 25 mL of deionized water and stirred at 200 r/min for 3 h. Then 0.12 g of calcium carbonate was added thereto, and continuously stirred at 200 r/min for 60 min. Finally, 0.41 g of gluconolactone was added to a resulting system and continuously stirred at 200 r/min for 1 min. A resulting solution was poured into a mold, and subjected to gel to obtain a sodium alginate hydrogel.

1.1 g of sodium periodate was mixed with 80 mL of deionized water to prepare a sodium periodate solution. 25 g of the sodium alginate hydrogel was added to 80 mL of the sodium periodate solution. A resulting mixture was subjected to oxidative ring-opening reaction under dark condition at 50° C. for 10 h to obtain an oxidized sodium alginate hydrogel.

25 g of the oxidized sodium alginate hydrogel was dispersed in 65 mL of dimethyl sulfoxide, and 1.5 mL of triethylene glycol and 1.5 mL of n-butyl lithium were added thereto. A pH value of a resulting reaction system was adjusted to 10 using lithium hydroxide. And a resulting mixture was subjected to aldol condensation reaction at a stirring speed of 300 r/min for 10 h to obtain a lithium-based sodium alginate hydrogel.

25 g of the lithium-based sodium alginate hydrogel was added to 80 mL of a hydrochloric acid solution. A concentration of the hydrochloric acid solution is 0.1 mol/L. A resulting system was subjected to acid-washing at a speed of 250 r/min for 1 h. A sample was washed and pre-cooled at −20° C. for 10 h, and then freeze-dried at −60° C. for 48 h to obtain a lithium-ion adsorption material.

### Example 4

0.75 g of sodium alginate was added to 25 mL of deionized water and stirred at 350 r/min for 1 h. Then 0.075 g of calcium carbonate was added thereto, and continuously stirred at 350 r/min for 30 min. Finally, 0.28 g of gluconolactone was added to a resulting system and continuously stirred at 350 r/min for 1 min. A resulting solution was poured into a mold, and subjected to gel to obtain a sodium alginate hydrogel.

0.8 g of sodium periodate was mixed with 80 mL of deionized water to prepare a sodium periodate solution. 28 g of the sodium alginate hydrogel was added to 80 mL of the sodium periodate solution. A resulting mixture was subjected to oxidative ring-opening reaction under dark condition at 45° C. for 11 h to obtain an oxidized sodium alginate hydrogel.

20 g of the oxidized sodium alginate hydrogel was dispersed in 50 mL of methanol, and 1.25 mL of diethylene glycol and 1.2 mL of benzyl lithium were added. A pH value of a resulting reaction system was adjusted to 12 using lithium hydroxide. And a resulting mixture was subjected to aldol condensation reaction at a stirring speed of 250 r/min for 12 h to obtain a lithium-based sodium alginate hydrogel.

22 g of the lithium-based sodium alginate hydrogel was added to 75 mL of a nitric acid solution. A concentration of the nitric acid solution is 0.15 mol/L. A resulting system was subjected to acid-washing at a speed of 200 r/min for 2 h. A sample was washed and pre-cooled at −10° C. for 12 h, and then freeze-dried at −65° C. for 50 h to obtain a lithium-ion adsorption material.

### Example 5

0.5 g of sodium alginate was added to 25 mL of deionized water and stirred at 350 r/min for 1 h. Then 0.045 g of calcium carbonate was added thereto, and continuously stirred at 350 r/min for 30 min. Finally, 0.23 g of gluconolactone was added to a resulting system and continuously stirred at 350 r/min for 1 min. A resulting solution was poured into a mold, and subjected to gel to obtain a sodium alginate hydrogel.

0.6 g of potassium permanganate was mixed with 80 mL of deionized water to prepare a potassium permanganate solution. 29 g of the sodium alginate hydrogel was added to 80 mL of potassium permanganate solution. A resulting mixture was subjected to oxidative ring-opening reaction under dark condition at 55° C. for 9 h to obtain an oxidized sodium alginate hydrogel.

23 g of the oxidized sodium alginate hydrogel was dispersed in 100 mL of acetonitrile, and 0.75 mL of dihydroxydibutyl ether and 0.6 g lithium carbonate were added thereto. A pH value of a resulting reaction system was adjusted to 11 using lithium hydroxide. And a resulting mixture was subjected to aldol condensation reaction at a stirring speed of 250 r/min for 12 h to obtain a lithium-based sodium alginate hydrogel.

24 g of the lithium-based sodium alginate hydrogel was added to 60 mL of a nitric acid solution. A concentration of the nitric acid solution is 0.2 mol/L. A resulting system was subjected to acid-washing at a speed of 200 r/min for 1 h. A sample was washed and pre-cooled at −30° C. for 8 h, and then freeze-dried at −55° C. for 55 h to obtain a lithium-ion adsorption material.

500 mL of aqueous solution with a lithium-ion concentration of 350 mg/L was selected for lithium-ion adsorption testing with 0.1 g of the lithium-ion adsorption material prepared in Examples 1 to 5, respectively. A test method was conducted as follows: adsorption was conducted using an intelligent dissolution tester at 30° C. for 24 h at a rotational speed of 100 r/min. After the adsorption was completed, a lithium-ion content in an adsorbed solution was measured using a full spectrum inductively coupled plasma emission spectrometer, and adsorption amount was calculated. The adsorption test results are shown in Table 1.

TABLE 1
Test results of lithium-ion adsorption

| | Example 1 | Example 2 | Example 3 | Example 4 | Example 5 |
|---|---|---|---|---|---|
| Adsorption | 112 | 506.029 | 359.46 | 205.926 | 67.06 |
| capacity | | | | | |
| mg/g | | | | | |

The lithium-ion adsorption material of the present disclosure exhibits an excellent adsorption performance, and the adsorption capacity for lithium ions is 60 mg/g to 550 mg/g.

The above descriptions are merely preferred embodiments of the present disclosure. It should be noted that a person of ordinary skill in the art may further make several improvements and modifications without departing from the principles of the present disclosure, but such improvements and modifications should be deemed as falling within the scope of the present disclosure.

What is claimed is:

1. A method for preparing a lithium-ion adsorption material, comprising:
1) mixing sodium alginate, calcium carbonate, gluconolactone and water to obtain a sodium alginate hydrogel;
2) soaking the sodium alginate hydrogel into an oxidizing solution, and subjecting a resulting solution to oxidative ring-opening reaction to obtain an oxidized sodium alginate hydrogel;
3) mixing the oxidized sodium alginate hydrogel, a dispersant, a solvent and a lithium-based compound, and subjecting an obtained mixture to aldol condensation reaction to obtain a lithium-based sodium alginate hydrogel; and
4) subjecting the lithium-based sodium alginate hydrogel to acid-washing and freeze-drying in sequence to obtain the lithium-ion adsorption material.

2. The method of claim 1, wherein in step 1), a mass to volume ratio of the sodium alginate, the calcium carbonate, and the gluconolactone to water is in a range of 0.5-1.25 g:0.045-0.12 g:0.16-0.41 g:25 mL.

3. The method of claim 1, wherein in step 2),
the oxidizing solution is selected from the group consisting of a potassium permanganate solution and a sodium periodate solution, a mass to volume ratio of the potassium permanganate to water in the potassium permanganate solution is in a range of 0.6-1.2 g:80 mL, and a mass to volume ratio of sodium periodate to water in the sodium periodate solution is in a range of 0.6-1.2 g:80 mL; and
a mass to volume ratio of the sodium alginate hydrogel to the oxidizing solution is in a range of 25-30 g:80 mL.

4. The method of claim 2, wherein in step 2),
the oxidizing solution is selected from the group consisting of a potassium permanganate solution and a sodium periodate solution, a mass to volume ratio of the potassium permanganate to water in the potassium permanganate solution is in a range of 0.6-1.2 g:80 mL, and a mass to volume ratio of sodium periodate to water in the sodium periodate solution is in a range of 0.6-1.2 g:80 mL; and
a mass to volume ratio of the sodium alginate hydrogel to the oxidizing solution is in a range of 25-30 g:80 mL.

5. The method of claim 3, wherein in step 2), the oxidative ring-opening reaction is conducted under a dark condition at a temperature of 40° C. to 60° C. for 8 h to 12 h.

6. The method of claim 5, wherein in step 3),
the dispersant is selected from the group consisting of dimethyl sulfoxide, anhydrous ethanol, methanol and acetonitrile;
the solvent is selected from the group consisting of diethylene glycol, triethylene glycol and dihydroxydibutyl ether;
the lithium-based compound is selected from the group consisting of n-butyl lithium, lithium carbonate, propyl lithium and benzyl lithium;
a mass to volume ratio of the oxidized sodium alginate hydrogel to the dispersant is in a range of 20-30 g:50-100 mL;
under the condition that the lithium-based compound is selected from the group consisting of the n-butyl lithium, the propyl lithium and the benzyl lithium, a volume ratio of the solvent to the lithium-based compound is in a range of 0.5-1.5:0.3-1.5, and a mass to volume ratio of the oxidized sodium alginate hydrogel to the lithium-based compound is in a range of 20-30 g:0.3-1.5 mL; and
under the condition that the lithium-based compound is the lithium carbonate, a volume to mass ratio of the solvent to the lithium-based compound is in a range of 0.5-1.5 mL: 0.2-1 g, and a mass ratio of the oxidized sodium alginate hydrogel to the lithium-based compound is in a range of 20-30:0.2-1.

7. The method of claim 6, wherein in step 3), the aldol condensation reaction is conducted at a pH value of 10 to 12 for 6 h to 18 h.

8. The method of claim 6, wherein in step 4), the acid-washing is conducted using an acid solution at a concentration of 0.05 mol/L to 0.2 mol/L, the acid solution is selected from the group consisting of hydrochloric acid and nitric acid; the acid-washing is conducted for 1 h to 2 h; and a mass to volume ratio of the lithium-based sodium alginate hydrogel to the acid solution is in a range of 22-32 g:50-80 mL.

9. The method of claim 7, wherein in step 4), the acid-washing is conducted using an acid solution at a concentration of 0.05 mol/L to 0.2 mol/L, the acid solution is selected from the group consisting of hydrochloric acid and nitric acid; the acid-washing is conducted for 1 h to 2 h; and a mass to volume ratio of the lithium-based sodium alginate hydrogel to the acid solution is in a range of 22-32 g:50-80 mL.

10. The method of claim 8, wherein in step 4), the freeze-drying is conducted at a temperature of −70° C. to −50° C. for 40 h to 60 h.

11. A lithium-ion adsorption material prepared by the method of claim 1.

12. The lithium-ion adsorption material of claim 11, wherein in step 1), a mass to volume ratio of the sodium alginate, the calcium carbonate, and the gluconolactone to water is in a range of 0.5-1.25 g:0.045-0.12 g:0.16-0.41 g:25 mL.

13. The lithium-ion adsorption material of claim 11, wherein in step 2),
the oxidizing solution is selected from the group consisting of a potassium permanganate solution and a sodium periodate solution, a mass to volume ratio of the potassium permanganate to water in the potassium permanganate solution is in a range of 0.6-1.2 g:80 mL, and a mass to volume ratio of sodium periodate to water in the sodium periodate solution is in a range of 0.6-1.2 g:80 mL; and
a mass to volume ratio of the sodium alginate hydrogel to the oxidizing solution is in a range of 25-30 g:80 mL.

14. The lithium-ion adsorption material of claim 11, wherein in step 2), the oxidative ring-opening reaction is conducted under dark condition at a temperature of 40° C. to 60° C. for 8 h to 12 h.

15. The lithium-ion adsorption material of claim 11, wherein in step 3),
the dispersant is selected from the group consisting of dimethyl sulfoxide, anhydrous ethanol, methanol and acetonitrile;
the solvent is selected from the group consisting of diethylene glycol, triethylene glycol and dihydroxydibutyl ether;
the lithium-based compound is selected from the group consisting of n-butyl lithium, lithium carbonate, propyl lithium and benzyl lithium;
a mass to volume ratio of the oxidized sodium alginate hydrogel to the dispersant is in a range of 20-30 g:50-100 mL;
under the condition that the lithium-based compound is selected from the group consisting of the n-butyl lithium, the propyl lithium and the benzyl lithium, a volume ratio of the solvent to the lithium-based compound is in a range of 0.5-1.5:0.3-1.5, and a mass to volume ratio of the oxidized sodium alginate hydrogel to the lithium-based compound is in a range of 20-30 g:0.3-1.5 mL; and
under the condition that the lithium-based compound is the lithium carbonate, a volume to mass ratio of the solvent to the lithium-based compound is in a range of 0.5-1.5 mL: 0.2-1 g, and a mass ratio of the oxidized sodium alginate hydrogel to the lithium-based compound is in a range of 20-30:0.2-1.

16. The lithium-ion adsorption material of claim 11, wherein in step 3), the aldol condensation reaction is conducted at a pH value of 10 to 12 for 6 h to 18 h.

17. The lithium-ion adsorption material of claim 11, wherein in step 4), the acid-washing is conducted using an acid solution at a concentration of 0.05 mol/L to 0.2 mol/L, the acid solution is selected from the group consisting of hydrochloric acid and nitric acid; the acid-washing is conducted for 1 h to 2 h; and a mass to volume ratio of the lithium-based sodium alginate hydrogel to the acid solution is in a range of 22-32 g:50-80 mL.

18. The lithium-ion adsorption material of claim 11, wherein in step 4), the freeze-drying is conducted at a temperature of −70° C. to −50° C. for 40 h to 60 h.
